(19) United States
(12) Patent Application Publication
(10) Pub. No.: US 2025/0061046 A1
(43) Pub. Date: Feb. 20, 2025

(54) Automatic Unit Test Generation Based On Execution Traces

(71) Applicant: Oracle International Corporation, Redwood Shores, CA (US)

(72) Inventors: Martijn T. Dwars, Zürich (CH); Patrick Eigensatz, Niederlenz (CH); Adam Zurada, Allenwinden (CH); Hugo Guiroux, Gland (CH)

(73) Assignee: Oracle International Corporation, Redwood Shores, CA (US)

(21) Appl. No.: 18/450,179

(22) Filed: Aug. 15, 2023

(51) Int. Cl. G06F 11/36

(52) U.S. Cl. CPC G06F 11/364; G06F 11/3684

(57) ABSTRACT

Techniques for automatically generating unit tests based on execution traces are disclosed. Trace data is traversed to identify a previously executed and traced target method, e.g., an initial version of the target method, and corresponding first set of input values and first return value used to invoke the initial version of the target method. Using the trace data, generating a test code for testing an updated version of the target method. Executing the test code includes invoking the updated version of the target method using the first set of inputs as arguments. In response to invoking the updated version of the target method, receiving a second return value. The second return value is compared to the first return value to determine whether the second return value matches the first return value. The results are then presented or stored.

### TECHNICAL FIELD

The present disclosure relates to unit testing of software systems. In particular, the present disclosure relates to automatic generation of unit tests based on observed behavior of the system.

### BACKGROUND

Automated software testing is the application of software tools to automate a human-driven manual process of reviewing and validating a software product. The simplest automated software testing method is unit testing. With unit testing, individual units of source code are tested to verify that the units meet the expected functionality and behavior.

Writing comprehensive unit tests can be time-consuming and require significant effort from developers. Manually creating test cases and setting up mocks can be tedious and detract from other development tasks. Writing unit tests for complex code can be challenging, especially when the code has many dependencies or involves complex data structures or algorithms. Testing edge cases and boundary conditions can be particularly difficult and require significant effort. Maintaining unit tests can be challenging, especially as the codebase evolves and changes over time. To ensure that unit tests provide value and accuracy, developers continuously need to update the unit tests to reflect changes in the system.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIGS. 2A and 2B illustrates an example set of operations for creating a trace file and generating a unit test from the trace file in accordance with one or more embodiments;

FIG. 3 is an example of source code of a class with an annotated method for tracing;

FIG. 4 is an example of source code for the class of FIG. 3, after transformation;

FIG. 5 is an example of source code including a class with a dependency to be mocked in a unit test;

FIGS. 6A and 6B is an example of source code of the class of FIG. 5, after transformation;

FIG. 7 is an example of source code of a class with a dependency that is shared in multiple @TestGen-annotated methods;

FIGS. 8A and 8B is an example of source code of the class of FIG. 7, after transformation;

FIG. 9A-9D are example tables describing structure of an example method trace;

FIGS. 10A and 10B is an example trace file resulting from execution of the source code of FIGS. 8A and 8B, after invoking the annotated method;

FIG. 11 is an example unit test generated for the example trace; and

FIG. 12 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. UNIT TEST GENERATION SYSTEM ARCHITECTURE
3. GENERATION OF UNIT TEST BASED ON EXECUTION TRACES
4. EXAMPLE AUTOMATIC GENERATION OF A UNIT TEST
5. HARDWARE OVERVIEW
6. MISCELLANEOUS; EXTENSIONS

### 1. General Overview

One or more embodiments generate a unit test based on observed behavior. The system-generated unit tests test whether the operation of a current version of a method matches the operation of a prior version of the same method. A system determines that the unit test is successfully passed when input/output combinations corresponding to the prior version of the method match input/output combinations corresponding to the current version of the method.

Initially, the system generates trace data by capturing (a) the input passed as an argument(s) to an initial version of a target method and (b) the output returned by the initial version of the target method. Based on the trace data, the system generates test code, e.g., a unit test, for testing an updated version of the target method. The test code is configured to invoke the updated version of the target method using the same input that was passed as an argument to the initial version of the target method and captured in the trace data. The test code is further configured to compare the output (return value), to be returned by the updated version of the target method, to the output (return value) in the trace data that was previously returned by the initial version of the target method.

One or more embodiments execute the test code to determine whether the behavior of the updated version of the target method matches the behavior of the initial version of the target method. Executing the test code includes invoking the updated version of the target method using the same input (e.g., one or more objects) as arguments that were passed as arguments to the initial version of the target method. The return value, returned by the updated version of the target method, is compared to the return value returned by the initial version of the target method and comprised in the trace data. The comparison operations determines whether the return values match. If the return values match, then the updated version of the target method is determined to have the same behavior as the initial version of the target method. If the return values do not match, then the updated version is determined to have a different behavior than the initial version of the target method. Detecting the same behavior may lead to the system determining that the unit test has been passed. Detecting different behavior may lead to the system determining that the unit test was failed. The system may store or present the results based on the comparison operations.

In one or more embodiments, the test code is further configured to instantiate the first set of objects prior to invoking the updated version of the target method and to instantiate an object of a type corresponding to the first return value returned by the initial version of the target method. The second return value, returned by the updated version of the target method, is compared to the object of the type corresponding to the return value. Presenting the test results includes indicating whether the updated version of the target method passed or failed the test. Alternatively, or in addition, presenting the test results includes indicating that the second return value is greater than the first return value or that the second return value is lower than the first return value.

One or more embodiments include creating the first set of objects using a constructor class, a setter method, or a builder class. The first set of input values and the first return value, having been serialized in the trace data, are used in constructing the first set of objects.

One or more embodiments include traversing trace data to identify a first method that was invoked by the initial version of the target method, a second set of input values that were received by the first method for execution of the first method, and a second return value that was returned by the first method to the initial version of the target method. The test code is further configured to create a proxy object on which the first method is invoked using the second set of input values and results in returning the second return value.

One or more embodiments gather the trace data by traversing the source code including the initial version of the target method to identify the initial version of the target method, to load a class, including the initial version of the target method, into a runtime environment, to capture the trace data during invocation of the initial version of the target method, and to serialize and store the trace data. Loading the class includes instrumenting byte code to trace the initial version of the target method. Storing the trace data includes storing the trace data outside the virtual machine, e.g., in a trace file on disk. Instrumenting the byte code to trace the initial version of the target method includes inserting instructions in the byte code immediately before any executable code of the initial version of the target method to capture a first state of the first set of the input values, and immediately before a return command of the initial version of the target method to capture the second return value.

Generating the trace data by traversing the source code to identify an annotation corresponding to the initial version of the target method and configuring generation of the trace data to trace the initial version of the target method based on the annotation corresponding to the initial version of the target method.

One or more embodiments described in this Specification and/or recited in the claims may not be included in this General Overview section.

### 2. Unit Test Generation System Architecture

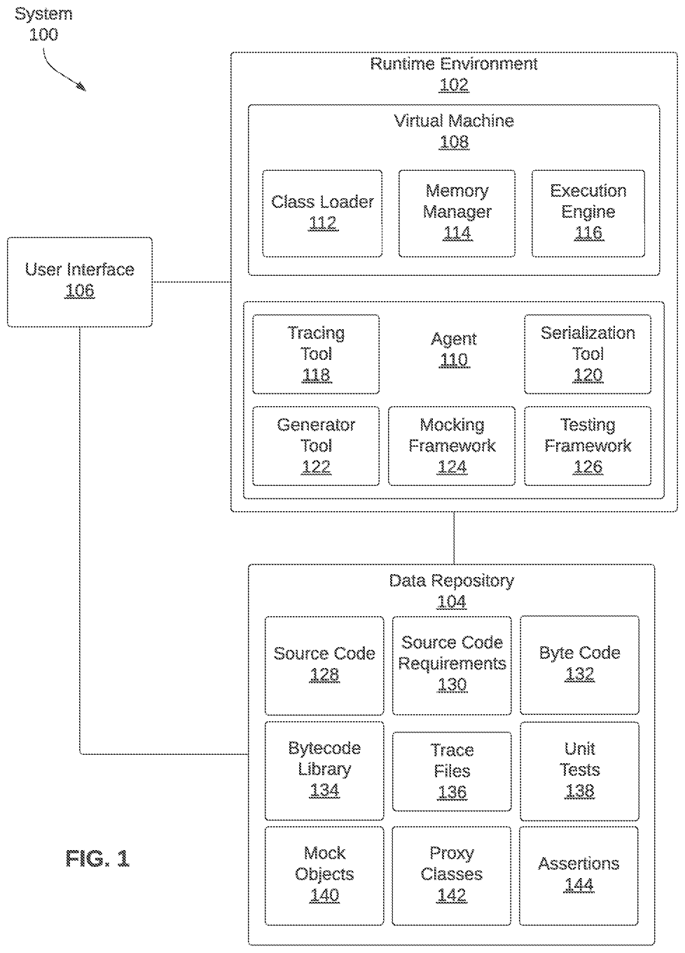

FIG. 1 illustrates a system 100 for automatically generating a unit test from observed behavior in accordance with one or more embodiments. As illustrated in FIG. 1, system 100 includes a runtime environment 102, a data repository 104, and a user interface 106. The runtime environment 102 hosts a virtual machine 108 and an agent 110 running alongside the virtual machine 108. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In one or more embodiments, the runtime environment 102 is the infrastructure or software framework that provides components and services for executing and running programs or applications. In some embodiments, the runtime environment 102 encompasses various resources and functionalities needed to support the execution of code. Different programming languages and platforms have their own specific runtime environments, with each runtime environment providing the necessary infrastructure and abstractions to support the execution of programs written in that language or targeted at that platform. For example, Java includes Java Runtime Environment (JRE) or Java Development Kit (JDK) that provides the necessary components to run Java applications. Similarly, other languages including Python, .NET, and Node.js have their own runtime environments tailored to the specific requirements of each language.

In one or more embodiments, the runtime environment 102 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, the virtual machine 108 is a software-based emulation of a computer system. The virtual machine 108 runs an operating system (OS) or multiple OSs on top of hardware of another physical machine. More particularly, the virtual machine 108 creates a virtual environment that acts as if the virtual environment were a separate, dedicated computer system, running its own OS and applications, even though the virtual machine 108 shares the physical resources of the host machine. In embodiments, the virtual machine 108 includes a class loader 112, a memory manager 114, and an execution engine 116.

In one or more embodiments, the class loader 112 of the virtual machine 108 is responsible for loading and dynamically linking classes and resources at runtime within the virtual machine environment. In embodiments, the class loader 112 locates and loads class files from various sources, such as file systems, networks, or other repositories. In some embodiments, the class loader 112 receives the name of a class and resolves the corresponding byte code or binary representation, transforming the code into a runtime representation that can be executed within the virtual machine 108.

In one or more embodiments, after loading the class, the class loader 112 performs a linking phase, which includes verification, preparation, and resolution. Verification ensures that the class file is well-formed and adheres to the rules of the virtual machine specification, e.g., Java Virtual Machine Specifications for Java-based virtual machines. Preparation involves allocating memory for class variables and initializing the class variables with default values. Resolution resolves symbolic references to other classes or resources. In embodiments, once the class is loaded and linked, the class loader triggers the initialization phase, in which static initialization blocks are executed, static variables are initiated, and static initializers are invoked, ensuring that the state of the class is properly initialized before use.

In one or more embodiments, the class loader 112 loads resources, such as configuration files, images, or other non-class files required by the application. In embodiments, these resources are accessed via a resource loading API. Different virtual machine implementations may have different class loading mechanisms and policies. For example, the Java Virtual Machine (JVM) has a hierarchical class loader system that includes a bootstrap class loader, an extension class loader, and an application class loader. Each class loader in the hierarchy has its specific responsibilities and class loading behavior.

In one or more embodiments, the memory manager 114 of the virtual machine 108 is responsible for managing the allocation and deallocation of memory within an execution environment of the virtual machine 108 in a way that maximizes efficiency and minimizes fragmentation. In some embodiments, the memory manager 114 is responsible for allocating memory for various objects and data structures created by the program running within the virtual machine 108. In embodiments, the memory manager 114 manages the allocation process, tracking available memory regions and assigning memory blocks to fulfill allocation requests.

In one or more embodiments, the execution engine 116 of the virtual machine 108 is responsible for executing the instructions of a virtualized guest operating system. The execution engine 116 interprets and processes the virtualized CPU instructions and manages the interaction between the virtual machine 108 and the underlying hardware.

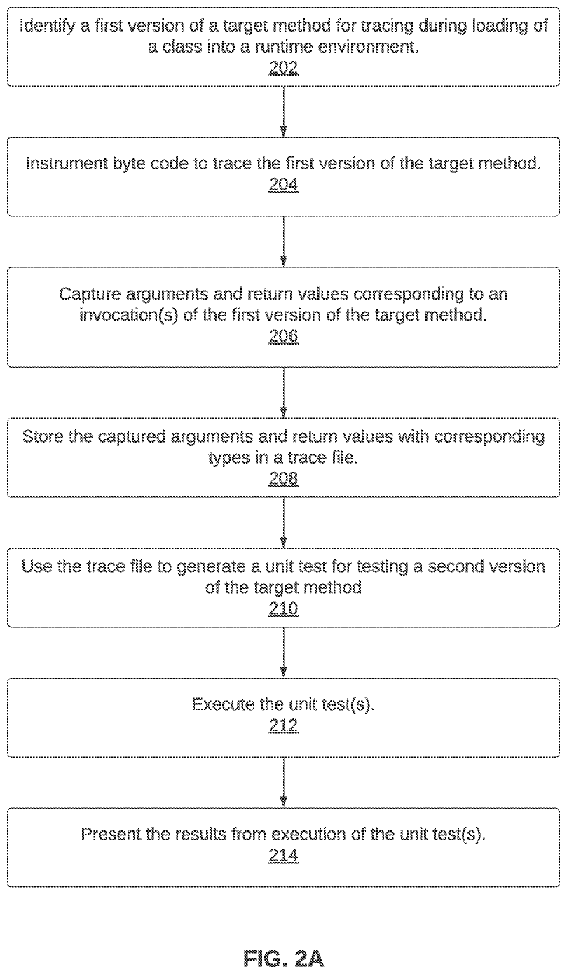

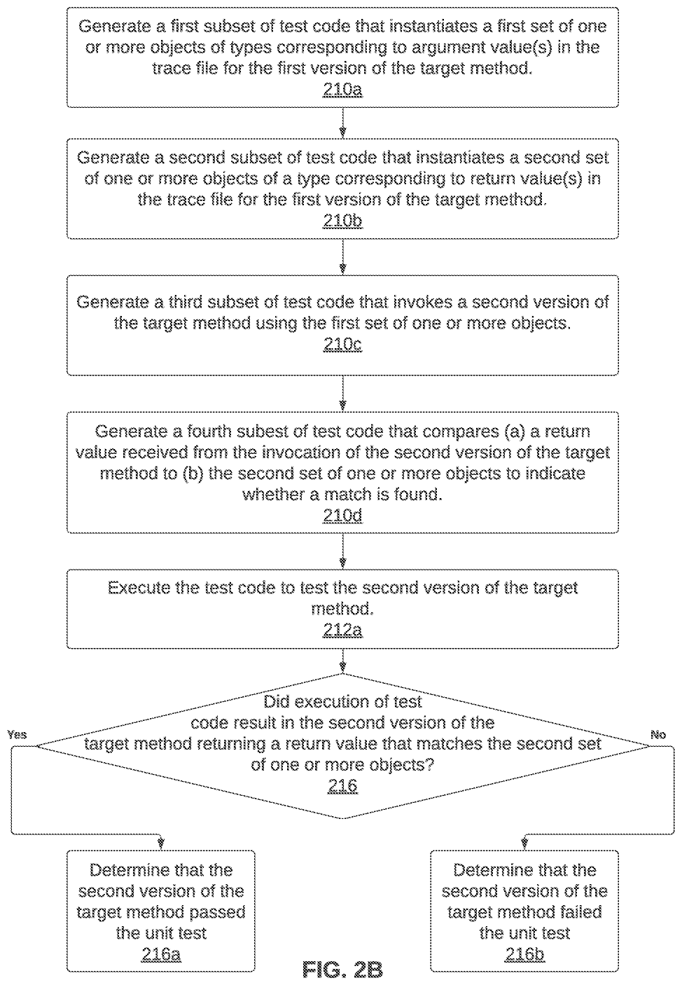

In one or more embodiments, the agent 110 for automatically generating unit test from observed behavior refers to hardware and/or software configured to perform operations described herein for creating an execution trace and using the execution trace to generate a unit test. Examples of operations for automatically generating a unit test from observed behavior are described below with reference to FIGS. 2A and 2B. In embodiments, the agent 110 is attached to the virtual machine 108 such that the agent 110 starts after the virtual machine 108 is started.

In one or more embodiments, the agent 110 includes a tracing tool 118, a serialization tool 120, a generator tool 122, mocking framework 124, and testing framework 126. Although operations will be described as relates to specific components, as noted above, the operations may be performed by one or more other or additional components.

In one or more embodiments, the tracer tool 118 of the agent 110 instruments the code of the software under test with tracing instructions. In some embodiments, the tracing instructions capture invocations of the method being traced. In embodiments, when a class is being loaded by the class loader 112, the tracer tool 118 identifies methods to be traced, also referred to as target methods or annotated methods. In some embodiments, a target method includes an annotation, e.g., @TestGen, that identifies to the tracer tool 118 that a method is to be traced. In some embodiments, the software developer provides the annotation in the source code 128.

In one or more embodiments, the tracer tool 118 uses a byte code library, e.g., Byte Buddy, to instrument byte code 132 with instructions to capture the arguments and return value of a target method at runtime. In embodiments, the tracer tool 118 instruments the byte code 132 to capture an exception, when thrown, instead of a return value. In embodiments, the tracer tool 118 instruments the byte code 132 to also capture invocations of a method on a dependency of the target method.

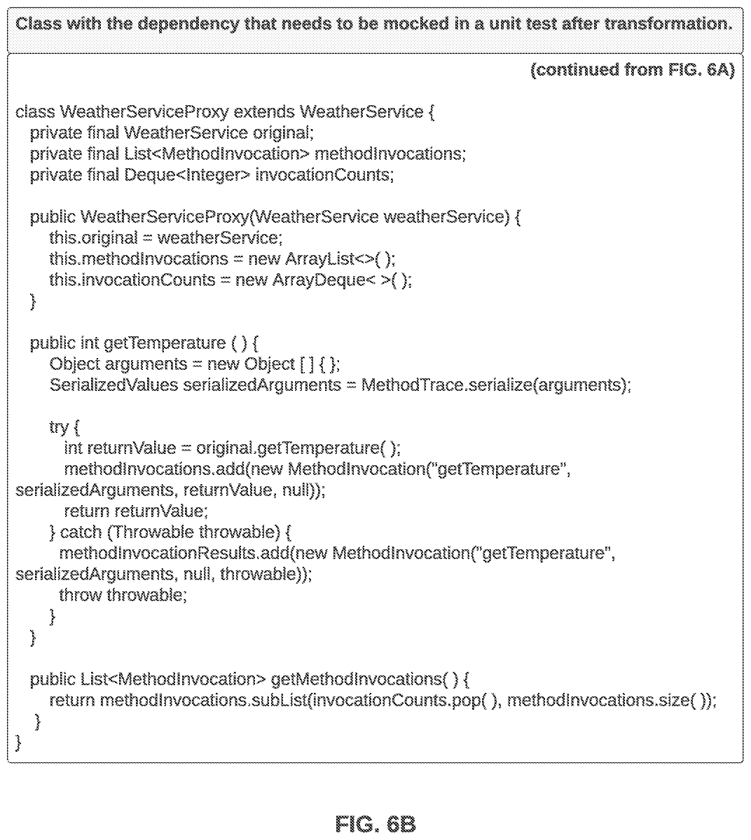

In one or more embodiments, the target method depends on other units or external resources such as databases, network connections, or file systems for which the tracer tool 118 creates a mock. In some embodiments, the mock created by the tracer tool 118 simulates the behavior of the dependency by accepting method calls and returning appropriate values. In embodiments, the software developer specifies which fields are dependencies by specifying the field names in the annotation, e.g., @TestGen (mocks={“weatherService”}) in FIG. 6A. In some embodiments, the tracer tool 118 creates a proxy class that is a subclass of the dependency. In embodiments, the proxy class has the same methods as the original class, and tracks each invocation of its method, including the arguments and the return value. In some embodiments, the tracer tool 118 instruments the byte code 132 to replace the dependency by a proxy object at the start of the method and reverses the change at the end of the method.

By replacing the dependencies with proxies, both direct calls and indirect calls (by a different method in the same class) on the dependency are captured. In one or more embodiments, when a class has multiple target methods, before replacing a dependency by a proxy, the tracer tool 118 performs a check to determine if the dependency was already replaced by a proxy. In embodiments, when the tracer tool 118 determines that the dependency has already been replaced by a proxy, the replacement is skipped. In this manner, all the target methods interact with the same proxy, and the proxy is able to track all invocations by the target method. In embodiments, the tracer tool 118 instruments the byte code 132 to revert the dependencies that were replaced by proxies back to the dependencies at the end of each target method.

In one or more embodiments, the tracer tool 118 instruments the byte code 132 such that a method trace for each target method is populated with the method invocations on the dependency that are relevant for that specific target method. In some embodiments, this is achieved by instrumenting the byte code 132 to push the current size of the method invocations of the proxy on a stack when entering a target method, and when exiting the method, only copying the method invocations after that size to the method trace and popping the size from the stack. In embodiments, the tracing tool 118 uses the stack to track a depth or level of the nested method invocations. In this manner, an inner target method only sees a subset of the calls, whereas an outer target method sees all the calls.

In one or more embodiments, the tracer tool 118 instruments the byte code 132 such that a field on a proxy, e.g., invocationCounts, is used to store how often a method on the proxy is invoked at the moment that another target method is entered. In this manner, when unraveling the call stack, the tracer tool 118 is able to identify which method calls on the proxy belong to each target method.

In one or more embodiments, the tracer tool 118 stores the captured or collected method traces external to the virtual machine 108 for later use. In embodiments, the tracing tool 118 stores the data persistently, such as in a file system or a database, or transmits the serialized data over a network to another system or application. In some embodiments, the data is stored as a trace file on a disk. In embodiments, the traces are stored when a certain number of traces have been collected or when the virtual machine 108 is terminated.

In one or more embodiments, the tracer tool 118 only records traces for calls that have not yet been encountered. By not storing duplicate calls of frequently executed methods, tracing overhead is reduced, and redundant test creation is prevented.

In one or more embodiments, the serialization tool 120 of the agent 110 is a software component or library that provides functionality to serialize objects into a specific format. Although shown as a separate component, the serialization tool 120 may be incorporated into the tracer tool 118. In embodiments, the serialization tool 120 simplifies the process of converting objects to bytes, handling the complexities of object graph traversal, data encoding, and storage. In some embodiments, the serialization tool 120 identifies annotations or configuration settings to be applied to the objects or classes to be serialized. These annotations or configurations provide instructions to the serialization tool 120 about how to handle specific fields or customize the serialization process. For example, the serialization tool 120 may include custom serialization code for data types that do not follow certain conventions, or where data is not stored in fields, e.g., java.util.* types. In embodiments, the serialization tool 120 reads the values, according to the implemented access mechanisms on that type, and serializes the values recursively to store the values in the trace file. In some embodiments, users provide serialization logic to enable explicit support for other types.

In one or more embodiments, when the arguments or return value is a primitive type or a string, the serialization tool 120 serializes the value to its corresponding JSON type (e.g., a Java integer becomes a JSON number, a Java String becomes a JSON string). In embodiments, when the value is an array, the serialization tool 120 serializes each element individually. In some embodiments, when the value is an object, the serialization tool 120 serializes all fields individually. In some embodiments, fields marked final, transient or synthetic fields are ignored. In embodiments, when the value is an enum, the name of the enum value is used to represent the specific value.

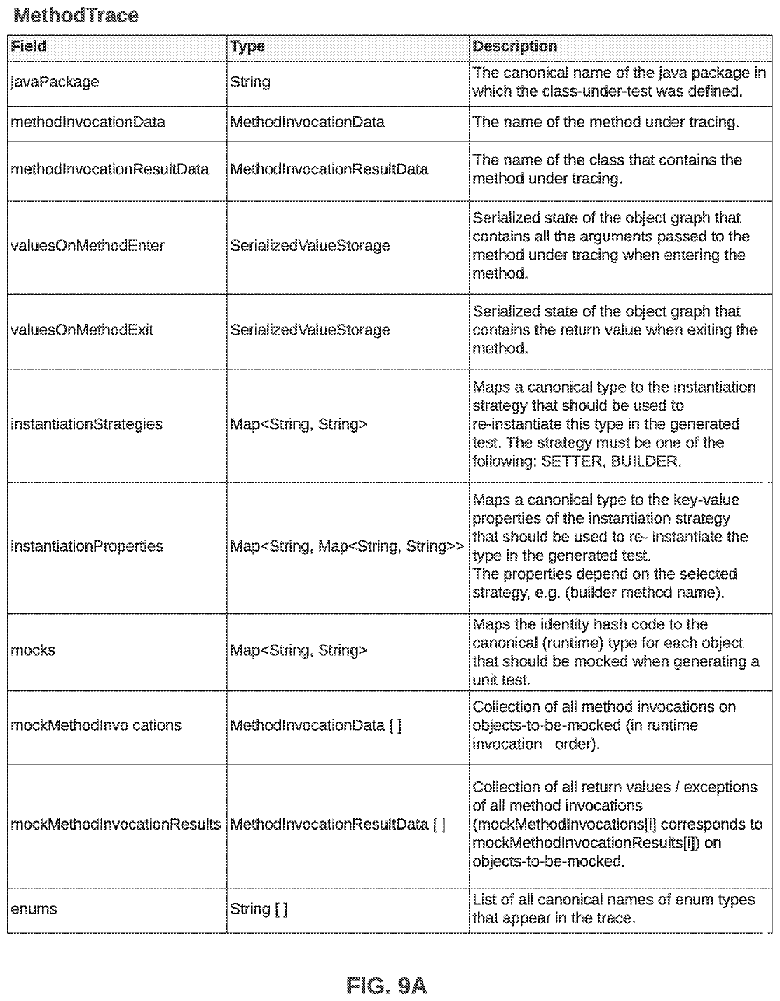

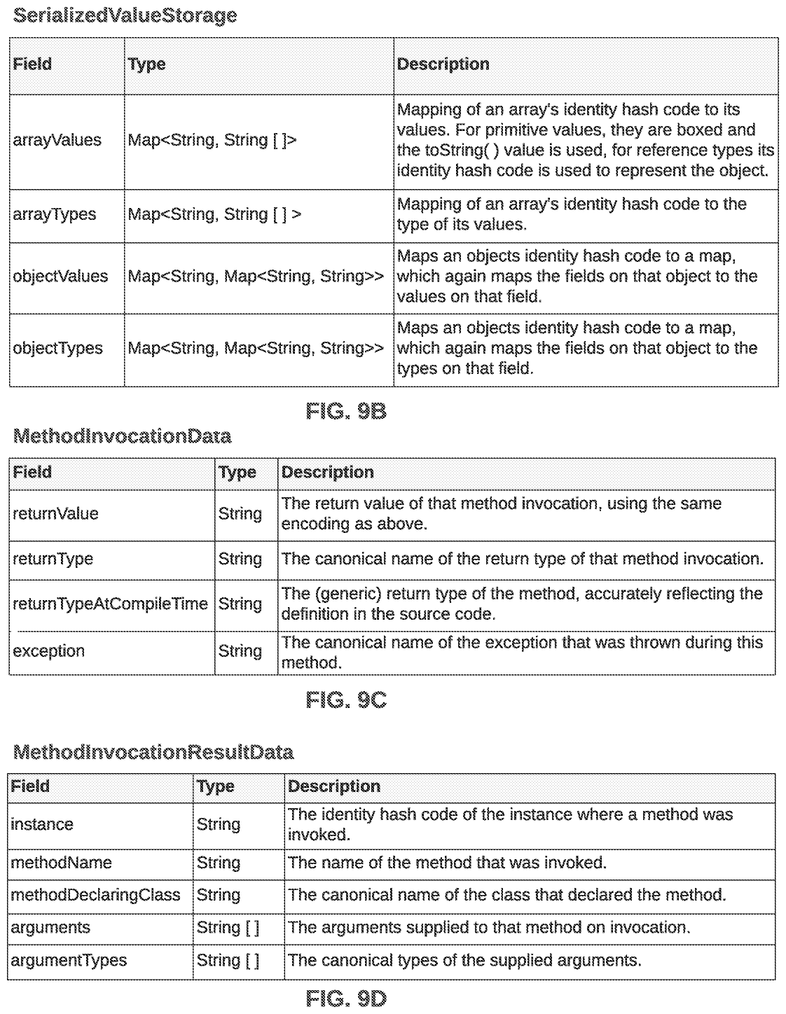

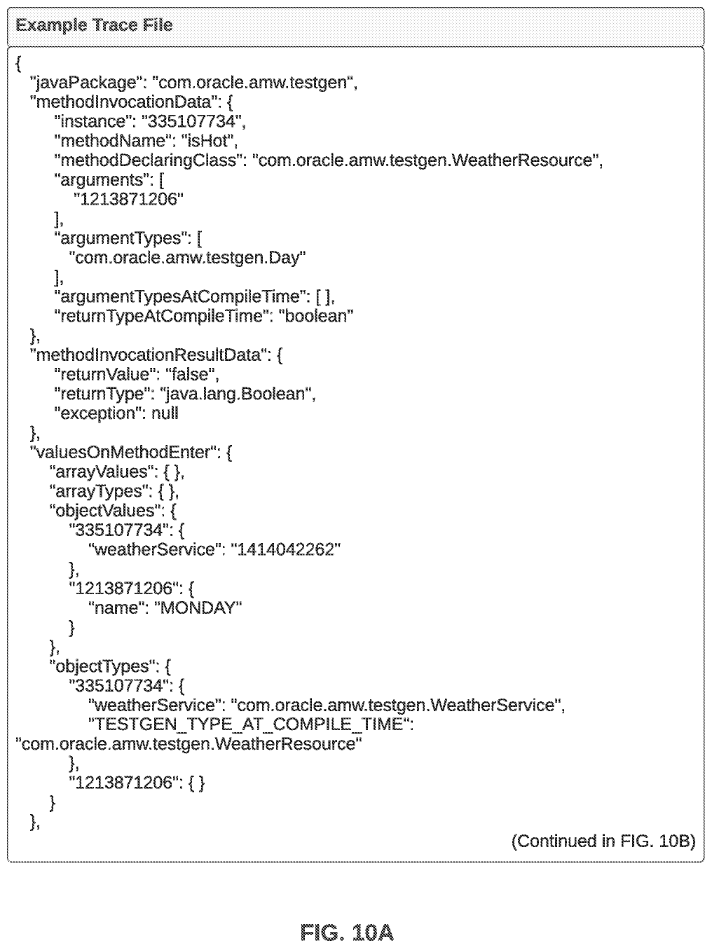

In one or more embodiments, when the serialization tool 120 is invoked to serialize an object or a graph of interconnected objects, the serialization tool 120 traverses the object graph and converts the object state into a serialized format, including encoding data of the object, such as its properties or fields, into a sequence of bytes according to a specific serialization format. In some embodiments, the serialization tool 120 determines the serialization format to be used, e.g., binary, XML, JSON, or a custom format, see, for example, FIG. 9B. Each format has its own rules and conventions for encoding object data into a byte sequence. In some embodiments, the serialization tool 120 encodes the data in the specified format.

In one or more embodiments, the serialization tool 120 functions on a per-object basis and supports serializing references to other objects. Particularly in Java, objects reference other objects. In one or more embodiments, an object graph is a collection of objects connected through references or pointers. In embodiments, the object graph represents relationships and dependencies between objects in a program. When objects reference each other, they form a network or structure known as the object graph. When an object graph is serialized, an entire interconnected structure of objects is represented in a way that can be saved or transmitted. This includes all the objects in the graph and the relationships of the objects with each other. When an object graph is serialized, the data (state) of each object in the object graph is captured and encoded into a serialized format. This includes the values of the attributes or properties of the object. Serialization preserves the relationships between objects in the object graph. When objects reference other objects, these references are represented in the serialized data. In some embodiments, when an object references another object within the object graph, the serialized data may contain a reference or identifier to the other object. These references are used to reconstruct the object graph with correct relationships. In some embodiments, the static Java Runtime Environment (JRE) method System.identityHashCode( ) is used to determine when any object references refer to the same object.

In one or more embodiments, once the state of an object is serialized, the serialization tool 120 stores the serialized data persistently, such as in a file system or a database, or transmits the serialized data over a network to another system or application. In embodiments, the serialized data is saved as a binary file, a text file, or as a stream of bytes. In one embodiment, the serialized data is saved in a JSON format.

In one or more embodiments, the generator tool 122 of the agent 110 takes a trace file including a captured trace as an input and produces a unit test for the captured trace as output. In some embodiments, the generator tool 122 generates a unit test in a specific language, e.g., Java, using a mocking framework, e.g., Mockito, to mock dependencies and stub method calls, and a testing framework, e.g., JUnit, to make assertions about the outcome.

In one or more embodiments, the generator tool 122 generates code that instantiates the arguments and expected return value, instantiates the mocks and stubbing method calls, and provides an assertion about the output. More particularly, in embodiments, the generator tool 122 reads all the stored traces and infers what method should be called and with what arguments. In embodiments, the generator tool 122 ensures all objects used by the method have been instantiated before calling the method-under-test. This involves generating code that reconstructs the objects and their state as the method-under-test was called during runtime. In embodiments, the generator tool 122 then picks appropriate assertions (like assertEquals, assertThrows) to ensure the unit test checks for the expected behavior of the method-under-test. The generator tool 122 may rely on POJO conventions and that data on object is set and modified through setters or builders to create readable code that instantiates the objects as observed during runtime. In some embodiments, the generator tool 122 is run completely detached from the runtime environment.

In one or more embodiments, the code generated by the generator tool 122 to instantiate a value is the same for arguments and return values, and is dependent on the type of value. More particularly, in embodiments, when the value is a primitive value (e.g. int, float, boolean, char), the generator tool 122 generates code that creates the literal value (e.g. 42, 1.23, false, ‘c’). In embodiments, when the value is an array, the generator tool 122 generates code to invoke the constructor recursively to instantiate each element of the array. In embodiments, variable declarations are generated to assign names to the instantiated values. In some embodiments, the inline array syntax is used to instantiate an array with the previously instantiated values as its elements.

In one or more embodiments, when the value is an arbitrary object, the generated code invokes the constructor recursively to instantiate the values for all fields of the object. Variable declarations may be generated to assign names to the instantiated values. An instance of the object may be created by generating a call to the no-arguments constructor. The object may further be instantiated by invoking setter methods, builder classes, or using reflection. A setter method, or setter, is a type of method used to set the value of an attribute of an object (also known as a property or member variable). The setter method provides a controlled way to modify the values of attributes of an object. The builder class, or builder, is a design pattern used to create objects with a complex construction process. The pattern separates the construction of an object from its representation, allowing for flexible and readable code when dealing with objects with numerous optional parameters. Reflection is a feature provided by many programming languages that allows a program to inspect and manipulate its own structure at runtime. Reflection enables a program to analyze and modify classes, methods, properties, and other components of the code dynamically at compile time.

In one or more embodiments, when the value is a collection-like object for which there is first-class support (e.g., Lists, Sets, Maps, Optional), the generated code invokes the constructor recursively to instantiate the elements of the collection. Depending on the type of collection, either the add (E e) or put (K k, V v) method may be used to add an element to the collection. In case of Optional, depending on whether a value is present, either Optional.empty or Optional. Of (V v) is used to reconstruct the value. In embodiments, when the value is a time object for which there is first-class support (e.g., Instant, LocalDate, LocalTime, LocalDateTime, ZonedDateTime, OffsetDateTime, OffsetTime), the value is instantiated by parsing the corresponding ISO date/time string. In embodiments, when the value is an enum, the implicit value Of method defined on enums is used to instantiate the value.

In one or more embodiments, the generator tool 122 maintains a map from an identity hash code (from the trace file) to the name of the variable that holds the value. In some embodiments, the identity hash code is a unique identifier assigned to each object by the virtual machine 108. In some embodiments, the identity hash code is derived from the memory address of the object. In embodiments, the hash code is an ‘int’ value that remains constant. In some embodiments, when code has already been generated to instantiate an object, the variable name is used instead of creating another instance of the object. In embodiments, in order to generate idiomatic unit tests, variable names are composed out of the name of the field followed by an incrementing integer.

In one or more embodiments, for each dependency, the generator tool 122 generates code that creates a mock by calling the mock (Class<T>) method. In some embodiments, he Class <T> value is based on the class name that is stored in the trace file. In some embodiments, using the mocking framework, a user can define method stubs using the syntax when (object.method(arg1, arg2, . . . )). thenReturn(value). In embodiments, the generator tool 122 generates a call for each trace method invocation. In embodiments, the same method used to instantiate the arguments and return values for the target methods are used to instantiate the arguments and return values for the method stubs.

In one or more embodiments, the generator tool 122 provides an expected outcome of either an equal return value, checked, for example, by using assertEqual, or an exception, checked, for example, by using assertThrows. In embodiments, the generator tool 122 is designed to be extensible, and can be easily adapted to cover other scenarios, i.e., asserting that the actual outcome is greater or lower than the expected outcome, that the outcome is empty, or, for example collections, that certain elements appear, or the actual order of data is irrelevant.

In one or more embodiments, the mocking framework 124 is a tool or library that creates mock objects for unit testing. In embodiments, the mocking framework enables simulation of dependencies or external components in order to isolate the unit being tested and verify behavior of the unit in a controlled manner.

In one or more embodiments, the mocking framework 124 of the agent 110 provides APIs or methods to create mock objects. In embodiments, these objects are created based on an interface, abstract class, or a concrete class, and mimic the behavior of the original objects. In some embodiments, the mock objects specify the behavior of their methods, such as defining return values, exceptions to be thrown, or callbacks to be executed, thereby simulating different scenarios and testing various code paths.

In one or more embodiments, the mocking framework 124 provides mechanisms to verify whether specific methods on mock objects have been invoked and how many times they have been invoked. This ensures that the unit under test interacts correctly with its dependencies. In some embodiments, the mocking framework 124 supports matching specific arguments passed to mocked methods to define more precise behavior based on the inputs of the method.

In one or more embodiments, the mocking framework 124 is used in conjunction with unit testing framework 126, such as JUnit for Java or NUnit for .NET, to write effective and reliable unit tests. In some embodiments, the mocking framework improves test coverage, isolates code units, and enhances the maintainability and stability of software systems.

The mocking frameworks are available for various programming languages. Examples of mocking frameworks include, Mockito, EasyMock, PowerMock, Moq, NSubstitute, Mockito.NET, and Sinon.JS. Mockito is a popular mocking framework for Java that provides an easy-to-use API for creating and configuring mock objects. Mockito allows defining of mock behavior, verifying of method invocations, and stubbing of method responses. EasyMock is another Java mocking framework that simplifies the creation of mock objects. EasyMock allows defining of expectations for method calls and specifying of return values or exceptions.

EasyMock supports both strict and nice mock behavior. PowerMock is an extension of Mockito and EasyMock that enables the mocking of static methods, final classes, and private methods in Java. PowerMock extends the capabilities of these frameworks by leveraging bytecode manipulation. Moq is a mocking framework for .NET languages such as C# and VB.NET. Moq provides a fluent API for defining mock behavior, setting up method expectations, and verifying method invocations. Moq supports both arrange-act-assert (AAA) syntax and behavior-driven development (BDD) style. NSubstitute is a mocking framework for .NET languages that offers a friendly syntax for creating mock objects. NSubstitute allows defining of behavior using natural and readable expressions. NSubstitute supports arranging method responses, verifying method calls, and defining argument matchers. Mockito.NET is a port of the Mockito framework for .NET languages. Mockito.NET provides similar features and syntax to the original Mockito framework, allowing developers to create and configure mock objects in .NET unit tests. Sinon.JS is a popular mocking framework for JavaScript. Sinon.JS supports stubbing, mocking, and spying on JavaScript functions, methods, and objects. Sinon.JS can be used with various testing frameworks, including Mocha, Jasmine, and Jest.

In one or more embodiments, the testing framework 126 of the agent 110 is a collection of tools, utilities, and conventions that provide a structured and standardized approach to writing, organizing, and executing software tests. The testing framework 126 simplifies the process of creating and running tests, making it easier for developers to validate the correctness and functionality of their code. Testing frameworks offer a set of functionalities that help in various aspects of software testing, including, test structure, test execution, assertion mechanism, setup and teardown, reporting and logging, mocking and stubbing,

In embodiments, the testing framework 126 provides a way to define test cases and organize the test cases into test suites. The test framework 126 may facilitate the execution of tests, automatically running all the defined test cases and reporting the results. In embodiments, the testing framework 126 includes assertion libraries that allow developers to define expected outcomes for tests. The testing framework 126 may support setup and teardown mechanisms to prepare the test environment before executing tests and clean up after tests are completed. The testing frameworks 126 may generate detailed reports and logs, helping developers identify which tests passed or failed and providing information about any errors encountered. In some embodiments, the testing framework 126 provides utilities for creating mock objects or stubs, enabling developers to isolate units of code for testing and to simulate behavior in controlled scenarios.

In one or more embodiments, the testing framework 126 is language specific. For example, JUnit is a testing framework for Java, focused on unit testing, pytest is a testing framework for Python, that supports unit tests, Mocha is a testing framework for JavaScript, commonly used in Node.js and browser-based applications, and NUnit is a testing framework for .NET languages, inspired by JUnit.

In one or more embodiments, the data repository 104 is any type of storage unit and/or device (e.g., a file system, database, collection of tables, or any other storage mechanism) for storing data. Further, the data repository 104 may include multiple different storage units and/or devices. The multiple different storage units and/or devices may or may not be of the same type or located at the same physical site. Further, the data repository 104 may be implemented or executed on the same computing system as the runtime environment 102 and the user interface 106. Alternatively, or additionally, the data repository 104 may be implemented or executed on a computing system separate from the runtime environment 102 and user interface 106. The data repository 104 may be communicatively coupled to the runtime environment 102 and user interface 106 via a direct connection or via a network.

Information describing automatically generating unit tests based on observed behavior may be implemented across any of the components within the system 100. However, this information is illustrated within the data repository 104 for purposes of clarity and explanation. In embodiments, the data repository 104 includes source code 128, source code requirements 130, byte code 132, a bytecode library 134, trace files 136, unit tests 138, mock objects 140, proxy classes 142, and assertions 144.

In one or more embodiments, the source code 128 is human-readable, text-based representation of a computer program written by a developer or programmer. In some embodiments, the source code 128 is a series of instructions, statements, and declarations that define the behavior and functionality of a software application. In embodiments, source code is typically written using a programming language, e.g., C++, Java, Python, JavaScript, or Ruby. Each programming language has its own set of keywords, syntax, and conventions. In some embodiments, the source code 128 serves as the input to the compilation or interpretation process that translates the code into executable machine code or byte code that can be run by the virtual machine 108.

In one or more embodiments, the source code 128 can be edited and modified by programmers to introduce new features, fix bugs, or improve functionality of the program. In some embodiments, developers make changes to the source code 128 using text editors or integrated development environments (IDEs). In embodiments, the source code 128 is organized into files and directories, with a logical structure that separates code into modules, classes, functions, or other units of code organization. This allows for modularization, code reuse, and easier collaboration among developers.

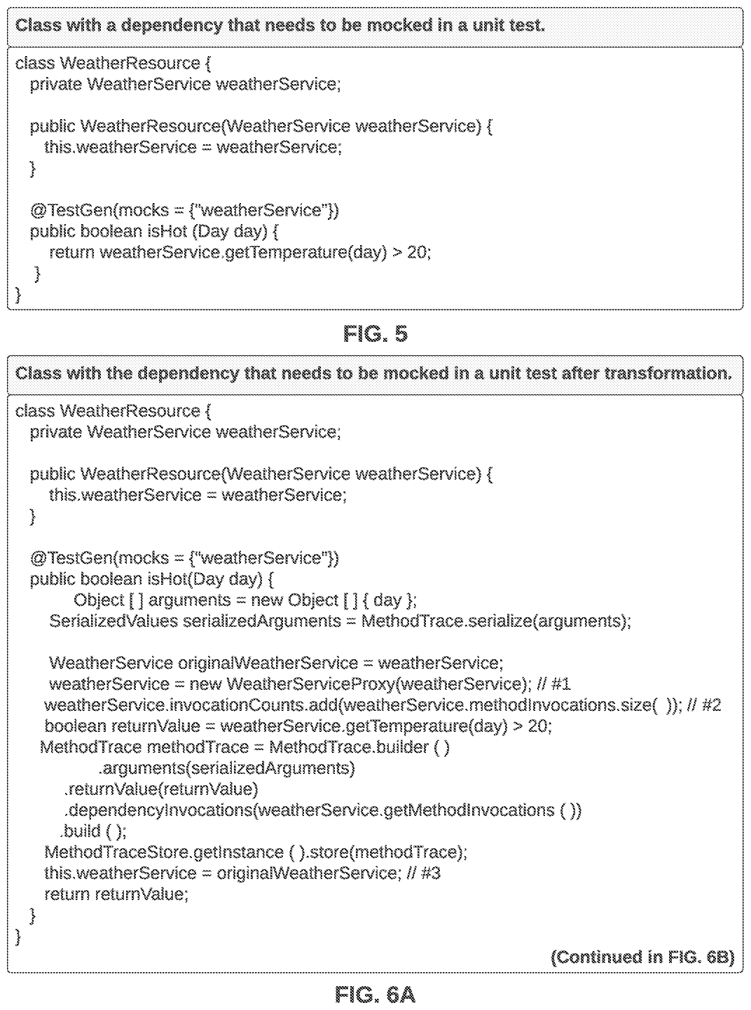

In one or more embodiments, the source code 128 includes source code representing a class. The class may have one or more target methods for which a unit test may be generated. In embodiments, the source code 128 is manually annotated by a software developer to include an annotation or marking that indicates that a unit test is to be generated for the method and that the method satisfies the source code requirements 130. The annotation to the methods in the source code does not affect operation of the methods. In one embodiment, the source code 128 for an annotated method includes @TestGen preceding the method, (see, for example, FIG. 5).

In one or more embodiments, source code 128 is transformed into executable code through a process of compilation or interpretation. Compilation converts the source code 128 into machine code specific to the target hardware, while interpretation involves executing the source code directly by an interpreter or the virtual machine 108.

In one or more embodiments, to enable automated unit test generation, a method for which a unit test is to be generated, e.g., target or annotated method, needs to satisfy source code requirements 130. In embodiments, the target method is required to be deterministic, i.e., the method produces a consistent output for a given set of inputs, regardless of the environment or the order in which the method is executed. When a method is not deterministic, the method does not always produce the same output when invoked with the same inputs, and any unit test generated for a non-deterministic method would be invalid. In some embodiments, non-deterministic behavior of a method is moved into a dependency such that the non-deterministic behavior can be mocked.

In one or more embodiments, the inputs, e.g., arguments or parameters, and outputs, e.g., return values, of the method for which a unit test is to be generated are primitive values, enums, arrays, or types that are explicitly supported. In some embodiments, the inputs and outputs are “plain old Java objects” (POJO) that (1) have a no-argument constructor, (2) allow setting properties using setter methods that follow a simple naming convention, and (3) implement an equals and hashCode method. A no-argument constructor, also referred to as a default constructor or zero-argument constructor, is a constructor in a class that takes no arguments, i.e., doesn't require any parameters to create an instance of the class, e.g., an object. A setter method, also referred to as a setter function or a mutator method, is a type of method in a class that allows external code to modify the values of private fields or properties of the class by providing a controlled and structured way to update a state of an object by setting new values for its attributes. In embodiments, implementing the equals( ) method and the hashCode( ) method in a class is a way to define how objects of that class are compared for equality and how they are used in hash-based data structures such as hash sets, hash maps, and hash tables.

In one or more embodiments, methods in dependencies must satisfy the same requirement as the target methods with regards the inputs and the outputs. In some embodiments, an additional requirement for methods in dependencies is that the method must not modify the inputs.

In one or more embodiments, a compiler converts the source code 128 to byte code 132 for execution in the virtual machine 108. In embodiments, the byte code 132 is instrumented by the tracer tool 118 to capture the invocation of target methods. In one or more embodiments, the byte code 132 is instrumented independent of the of the agent 110 and/or the byte code 132 is instrumented at an earlier time.

In one or more embodiments, the byte code library 134 is used for creating and modifying classes at runtime. The byte code library 134 provides a convenient and flexible way to generate dynamic classes, proxy objects, and apply various byte code transformations.

In one or more embodiments, the byte code library 134 is Byte Buddy. Byte Buddy is commonly used in Java frameworks, Aspect-Oriented Programming (AOP) implementations, and other scenarios to perform runtime class manipulation. In embodiments, Byte Buddy enables modification of existing byte code of Java classes at runtime. Using a byte code library 134, like Byte Buddy, simplifies creation of dynamic proxies, allowing for creation of proxy objects that implement one or more interfaces and intercept method calls for custom behavior.

In one or more embodiments, the byte code library 134 provides utilities for creating new annotations and adding them to classes at runtime. In some embodiments the byte code library 134 is designed to work well with other Java libraries and frameworks. For example, Byte Buddy includes integrations with popular tools, including Mockito and JUnit.

In one or more embodiments, by providing a high-level API for byte code manipulation, the byte code library 134 allows developers to perform complex class transformations and dynamic code generation tasks without the need to deal with low-level byte code manipulation directly.

In one or more embodiments, the captured data or execution traces are stored in trace files 136. The trace files 136 are a self-contained data structure that each contain all the information required to generate a unit test. In embodiments, each of the trace files 136 identifies a signature of the target method that includes which method it is and which class it belongs to, the arguments passed to, and objects returned by the target method. When the target method is an overloaded method with multiple arguments, the target method may have a signature which defines exactly the method type based on the return values, the name and the types of arguments. In embodiments, the method signature is mapped to the target method.

In one or more embodiments, when the value is of a primitive type or a string, the value is serialized to its corresponding JSON type (e.g., a Java integer becomes a JSON number, a Java String becomes a JSON string) before being stored in the trace file 136. In embodiments, when the value is an array, each element is serialized individually before being stored in the trace file 136; when the value is an object, all fields are serialized individually before being stored in the trace file 136; and when the value is an enum, the name of the enum value is used to represent the specific value and is stored in the trace file 136.

In one or more embodiments, for generic types, static as well as dynamic type information is stored in the trace file 136, which allows for reconstructing the used types at test generation time. In embodiments that include nested parameterized types, such as List<List<String>>, generating a test that respects the rules of Java's type system requires reliance on a combination of this trace data.

In one or more embodiments, the unit tests 138 are a type of software testing where individual units or components of a program are tested in isolation to ensure that the units function as intended. In embodiments, the unit test is automatically generated using trace data captured from invocation of a first, initial version of a target method. Execution of the unit test is performed on a second, later version of the target method. By executing the unit tests on the later version of the source code, software developers can ensure that the original behavior of the target method remains intact. In some embodiments, unit testing verifies the correctness and reliability of the individual units, e.g., methods, functions, classes, or modules, independently from the rest of the program. For example, when a unit test passes after making changes to the source code, software developers can be confident that the change to the source code did not break any existing functionality of the target method.

In one or more embodiments, unit testing focuses on isolating a specific unit of code, e.g., a method or function, and testing the unit in isolation from its dependencies. In some embodiments, dependencies are replaced with test doubles, e.g., mock objects or stubs, to control the behavior of the dependencies and ensure that the unit under test is tested independently. In embodiments, each unit test is independent and self-contained, meaning that the unit test does not rely on the success or failure of other tests. This allows for easy identification and isolation of issues when a unit test fails.

In one or more embodiments, the unit tests 138 are automated to enable quick and frequent execution. In embodiments, automated testing frameworks and tools, e.g., JUnit for Java or pytest for Python, provide structures and utilities for writing and executing unit tests efficiently. In some embodiments, the unit tests 138 aim to achieve high code coverage by exercising various scenarios and paths within the unit being tested. When a system running in production does not meet this criterium, then a software developer writes additional tests that resemble the inputs and outputs of the system in production. Generating unit tests based on observed behavior of the system, e.g., arguments and return values captured at runtime, makes it easier to meet the code-coverage criterium. Additionally, software developers typically write programs and execute the programs with sample inputs prior to creating unit tests. Generating unit tests based on these sample invocations would increase efficiency.

In one or more embodiments, the unit tests 138 are executed automatically whenever changes are made to the source code 128 to ensure that modifications do not introduce regressions or break existing functionality. In some embodiments, a unit test is written in a specific format or structure that follows certain conventions. The exact format may vary depending on the testing framework or programming language used. The unit tests 138 may be written using unit testing framework specific to the programming language, e.g., JUnit for Java, NUnit for .NET, or pytest for Python. The test framework provides the infrastructure and utilities for defining and executing unit tests.

In one or more embodiments, the unit tests 138 are organized into test classes that contain multiple test methods. In some embodiments, each test class focuses on testing a specific class or component of the system. In embodiments, a unit test is implemented as a method within the test class. Each test method may focus on testing a specific behavior or functionality of the unit being tested. In some embodiments, test methods are public and are annotated or named following a specific convention defined by the testing framework 126.

In one or more embodiments, the unit tests 138 include assertions 144 that verify whether the actual output or behavior matches the expected outcome. In some embodiments, assertions 144 are used to check whether the unit under test behaves correctly in various scenarios. In embodiments, the testing framework 126 provides a range of assertion methods to compare values, check conditions, and assert expected exceptions.

In one or more embodiments, the mock objects 140 are objects that mimic the behavior of real objects but are specifically designed for testing purposes. In some embodiments, mock objects replace real dependencies, such as database connections, web services, or complex objects, with controllable and predictable substitutes.

In one or more embodiments, the mock objects 140 stub out certain behavior or responses of external dependencies to simulate different outcomes and test specific conditions in your unit tests. In some embodiments, the mocking frameworks 124 provide APIs to configure and customize the mock objects 140, such as setting up default behaviors, resetting mock states, or specifying strict or lenient behavior.

In one or more embodiments, the proxy class 142 is a subclass of a dependency. In some embodiments, the proxy class 142 has the same methods as the original class, and keeps track of each invocation of its methods, including the arguments and return values.

In one or more embodiments, the assertions 144 are statements that check whether a certain condition is true during the execution of a unit test. The assertions 144 verify the correctness of the code under test. When writing unit tests, developers use the assertions 144 to express expected outcomes and compare the expected outcomes to actual results produced by the code being tested. In embodiments, the assertions 144 include a test expression that evaluates to either true (indicating the test passed) or false (indicating the test failed). When the assertion evaluates to false, the unit testing framework reports the failure, providing feedback to the developer.

In one or more embodiments, common types of assertions used in unit tests include equality assertions that check if two values are equal, inequality assertions, that verify that two values are not equal, null assertions that verify that a value is null, non null assertions that verify that a value is not null, Boolean assertion that check if a Boolean condition is true or false, exception assertions that check whether a specific exception is thrown during the execution of the code, collection assertions that verify the content and size of collections like lists, sets, or maps, and custom assertions that are tailored to a specific testing need.

In one or more embodiments, the choice of the assertions 144 depends on what is being tested and what the expected behavior of the code is. In embodiments, the assertions 144 are clear and meaningful and cover relevant use cases and edge cases.

In one or more embodiments, the user interface 106 refers to hardware and/or software configured to facilitate communications between a user and the virtual machine 108 and agent 110 in the runtime environment 102 and the data repository 104. The interface 106 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of the interface 106 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, the interface 106 is specified in one or more other languages, such as Java, C, or C++.

### 3. Generating Unit Tests Based on Execution Traces

FIGS. 2A and 2B illustrate an example set of operations for generating a unit test based on an execution traces in accordance with one or more embodiments. One or more operations illustrated in FIGS. 2A and 2B may be modified, rearranged, or omitted all together. Accordingly, the particular sequence of operations illustrated in FIGS. 2A and 2B should not be construed as limiting the scope of one or more embodiments.

One or more embodiments include identifying a target method for tracing during loading of a class into a runtime environment. (Operation 202). In one or more embodiments, a virtual machine, e.g., Java Virtual Machine, is started along with an agent for generating unit tests. The agent may be attached to the virtual machine. In embodiments, when a class is loaded in the virtual machine, the agent is notified and identifies target methods for tracing.

In one or more embodiments, source code for a class that includes a method for which a unit test is to be generated, e.g., annotated method or target method, includes annotation to identify the method. In some embodiments, software developers annotate the target method in the source code. In some embodiments, machine learning models and/or other artificial intelligence techniques are used to identify methods in source code for tracing. In embodiments, annotating the source code for the target method includes inserting a notation, e.g., @GenTest, in the source code to identify the target method to a class loader loading the source code into a virtual machine.

In one or more embodiments, the target method satisfies certain requirements. In embodiments, the target method is deterministic. In embodiments including non-deterministic behavior, the non-deterministic behavior is moved into a dependency such that the non-deterministic behavior can be mocked. In addition to being deterministic, in embodiments, the input values, e.g., arguments or parameters, and output values, e.g., return values, to the target method are primitive values, enums, arrays, or types that are explicitly supported. Alternatively, the input and output values may be “plain old Java objects” (POJO) that (1) have a no-argument constructor, (2) allow setting properties using setter methods that follow a simple naming convention, and (3) implement an equals and hashCode method.

One or more embodiments instrument byte code to trace the target method. (Operation 204). In some embodiments, a tracing tool inserts, or interweaves, instructions into the byte code of the class to trace invocations of the target method and capture input values and output values. In embodiments, the instructions are inserted by the tracer tool into the byte code of the class immediately before any executable code of the method and again immediately before the method returns any output. In some embodiments, the instructions insert code to capture the input values, e.g., arguments provided to the method, before any modifications to the arguments, and capture the output values, e.g., return values, when the target method is invoked. In embodiments, the tracing tool uses a byte code library, e.g., Byte Buddy, to instrument the byte code during loading.

In some embodiments, instrumenting the byte code also includes inserting a proxy class for each of the dependencies to capture calls to dependency.

Although the instrumentation of the source code is described as being an automated process that occurs as part of loading of the class containing the target method into the virtual machine, in some embodiments, the instrumentation of the source code is completed independent of the virtual machine, e.g., manually by the software developer, and/or at an earlier point in time, i.e., separate from invocation of the target method. The independently and/or separately formed instrumented code may be saved to disk for later use.

One or more embodiments capture arguments and return values corresponding to an invocation(s) of the target method. (Operation 206). In embodiments, when the target method is invoked, the instructions inserted into the byte code for the method capture the expected input and output behavior of the target method. In some embodiments, every method invocation results in a single encapsulated instance in memory. In embodiments, capturing the arguments includes capturing all the data of the instance such that the instance can be recreated. In some embodiments, when an exception is thrown, the exception is also captured. In embodiments, the captured parameters are temporarily stored in the heap of the virtual machine.

One or more embodiments store the captured arguments and return values with corresponding types in a trace file. (Operation 208). In embodiments, the captured data, i.e., execution trace, is serialized prior to storing each execution trace in the trace file. In some embodiments, the captured data is serialized in accordance with its type. Serializing captured data materializes the data and allows the data to be stored outside of the virtual machine for future use. In some embodiments, serialization converts a state of an object into a format that can be easily stored, transmitted, or reconstructed. When an object is serialized, the data of the object (attributes or properties) are captured to be persisted in a file, database, or transmitted over a network. In some embodiments, the serialized data is stored in a trace file on a disk.

One or more embodiments use the trace file to generate test code, e.g., a unit test, for testing an updated version of the target method. (Operation 210). In embodiments, a generator tool traverses trace data in the trace file to identify (a) a target method that was previously executed and traced, e.g., an initial version of the target method, (b) a first set of one or more input values that were received by the initial version of the target method for execution of the initial version of the target method, and (c) a first return value that was returned by the initial version of the target method.

In embodiments, the generator tool generates test code for testing a updated version of the target method based on the trace data. More particularly, the generator tool may generate test code that invokes the updated version of the target method using a first set of one or more objects of the type corresponding to the one or more inputs values and comprising the one or more input values. In embodiments, the generator tool uses a setter class, a constructor method, or a builder class to create the first set of one or more objects. In some embodiments, one or more reflection operations are used to instantiate the first set of one or more objects. In embodiments, the generator tool generates test code for constructing the first set of one or more objects using the first set of one or more input values serialized in the trace data.

In one or more embodiments, using the trace file to generate test code further includes traversing trace data to identify (a) a first method that was invoked by the initial version of the target method, (b) a second set of one or more input values that were received by the first method for execution of the first method, and (c) a second return value that was returned by the first method to the initial version of the target method. In embodiments, the generator tool generates test code to create a proxy object. In some embodiments, invoking the first method on the proxy object using the second set of one or more input values results in returning the second return value.

In one or more embodiments, the generator tool generates code that compares a second return value to be returned by the updated version of the target method in response to invoking the updated version of the target method to the first return value in the trace data.

One or more embodiments execute the unit test(s). (Operation 214). In some embodiments, executing the unit test comprises invoking the updated version of the target method using the first set of one or more objects as arguments, receiving the second return value returned by the updated version of the target method in response to invoking the updated version of the target method, and comparing the second return value to the first return value comprised in the trace data to determine whether the second return value matches the first return value. In embodiments, executing the unit test further includes determining test results based on comparing the second return value to the first return value, and presenting or storing the test results.

One or more embodiments generate a first subset of test code that instantiates a first set of one or more objects of types corresponding to argument values(s) in the trace file for the initial version of the target method. (Operation 210a). In embodiments, the first subset of test code uses a setter class, a constructor method, or a builder class to instantiate the first set of one or more objects. In some embodiments, one or more reflection operations are used to instantiate the first set of one or more objects.

One or more embodiments generate a second set of test code that instantiates a second set of one or more objects of a type corresponding to return value(s) in the trace file for the initial version of the target method. (Operation 210b). In embodiments, the second set of test code uses the same methods or classes used to instantiate the first set of one or more objects to instantiate the return values.

One or more embodiments generate a third subset of test code that invokes the updated version of the target method using the first set of one or more objects. (Operation 210c).

One or more embodiments includes determining if execution of test code results in the updated version of the target method returning a return value that matches the second set of one or more objects. (Operation 216). In embodiments, the determination is made by comparing the second return value to the first return value comprised in the trace data.

One or more embodiments determine that the updated version of the target method passed the unit test. (Operation 216a). In embodiments, the updated version of the target method is determined to have passed the unit test when execution of the test code results in the updated version of the target method returning a return value that matches the second set of one or more objects, e.g., the return value from the invocation of the initial version of the target method during tracing. In this manner, any changes to the source code made subsequent to the invocation of the initial version of the target method that resulted in the trace upon which the test unit is generated did not affect the functionality of the source code for the updated version of the target method.

One or more embodiments determines that the updated version of the target method failed the unit test. (Operation 216b). In embodiments, the updated version of the target method is determined to have failed the unit test when execution of the test code results in the updated version of the target method returning a return value that does not match the second set of one or more objects, e.g., the return value from the invocation of the initial version of the target method during tracing. In some embodiments, presenting a determination that the updated version of the target method failed the unit test includes presenting indication that the second return value is greater than the first return value or that the second return value is lower than the first return value.

### 4. Example Automatic Generation of a Unit Test

A detailed example is described below for purposes of clarity. Components and/or operations described below should be understood as one specific example which may not be applicable to certain embodiments. Accordingly, components and/or operations described below should not be construed as limiting the scope of any of the claims.

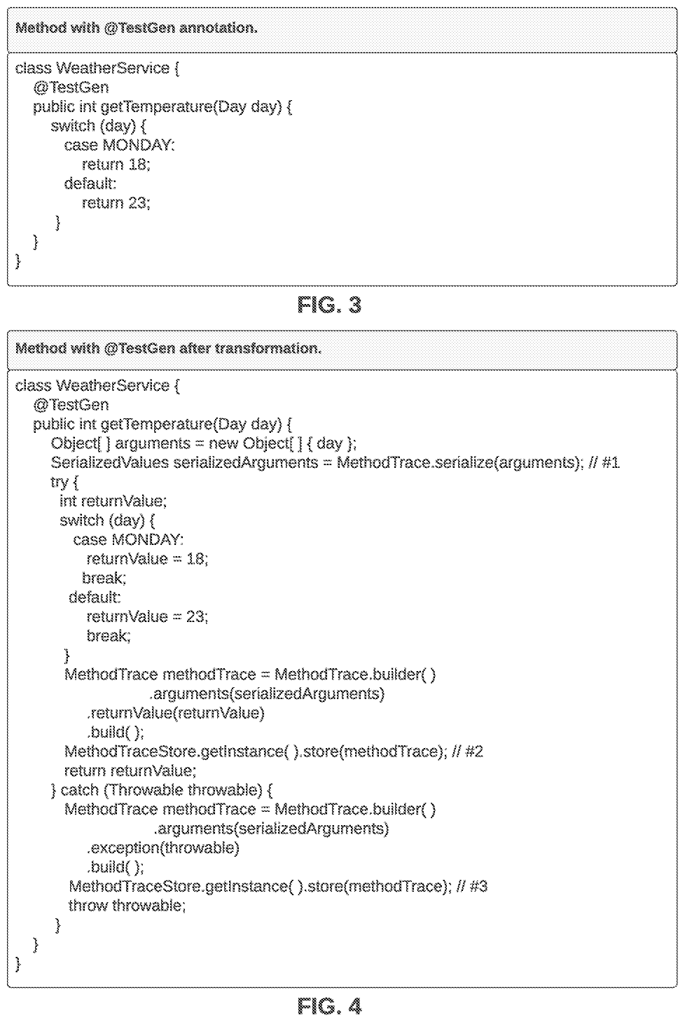

FIG. 3 is source code for a class with an annotated method for tracing. The class weatherService includes a method getTemperature. The source code includes annotation, e.g., @TestGen, identifying the getTemperature method as a method to be traced or target method. The annotation is provided by the software developer. The target method takes a parameter Day and returns a value int. Although implementation of the unit test generation in a Java Virtual Machine (JVM) uses byte code, for illustrative purposes and readability, the equivalent Java source code is shown.

FIG. 4 is the source code for the class weatherService after transformation. More particularly, the source code for the weatherService class is instrumented to include code that stores the arguments input into the target method as well as the return values output by the target method in a MethodTrace which is stored in a MethodTraceStore. The transformed source code includes instrumentation, at #1, that serializes the arguments input into the target method at the start of the method to capture the state of the arguments before capture of any modification to the argument. At #2, code is inserted that creates and stores a MethodTrace object. The MethodTrace contains the serialized arguments as well as the return value. At #3, code is inserted to capture and store an exception, if thrown, instead of the return value.

FIG. 5 is source code including a class with a dependency to be mocked in a unit test. More particularly, the class WeatherResource includes a dependency on weatherService. The tracer modifies the source code to create a proxy class that is a subclass of the dependency. The proxy class has the same methods as the original class, and keeps track of each invocation of its methods, including the arguments and return values. The code is instrumented to replace the dependency with the proxy object at the start of the method, with the change reverted at the end of the method. The software developer specified which fields are dependencies by specifying the field names in the @TestGen annotation, e.g., @TestGen (mocks={“weatherService”}). An assumption was made that dependencies are always configured on the containing class.

FIGS. 6A and 6B are the source code of the class WeatherResource after transformation. At #1, the source code for the weatherService #isHot method is instrumented such that when entering the method, the value of the weatherService field is replaced by a proxy object. At #3, the source code is instrumented to replace the value of the weatherService field by the original object when leaving the method. If the isHot method would call a method in the WeatherResource class that in turn calls a method on the weatherService, then the latter call is also made on the weatherService proxy. In this manner, all calls to methods on the dependency (either directly or indirectly) are captured by the proxy.

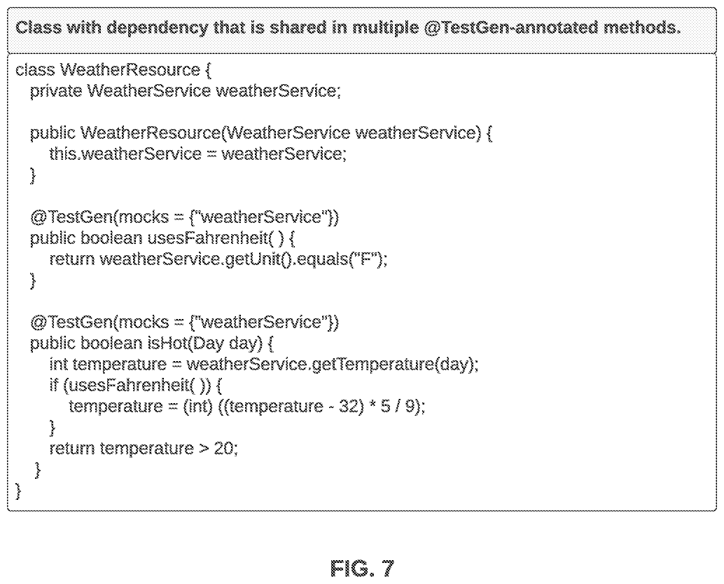

FIG. 7 is source code of a class with a dependency that is shared in multiple @TestGen-annotated methods. More particularly, as shown, the WeatherResource class has two @TestGen-annotated methods usesFahrenheit and isHot that each invoke some method on the weatherService dependency. Additionally, the method isHot calls the method usesFahrenheit.

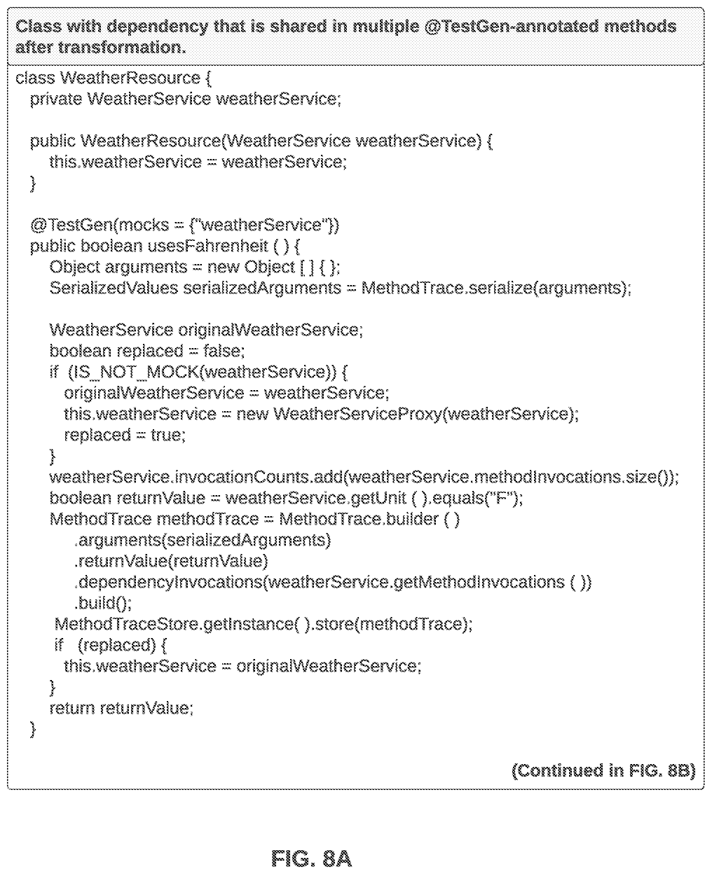

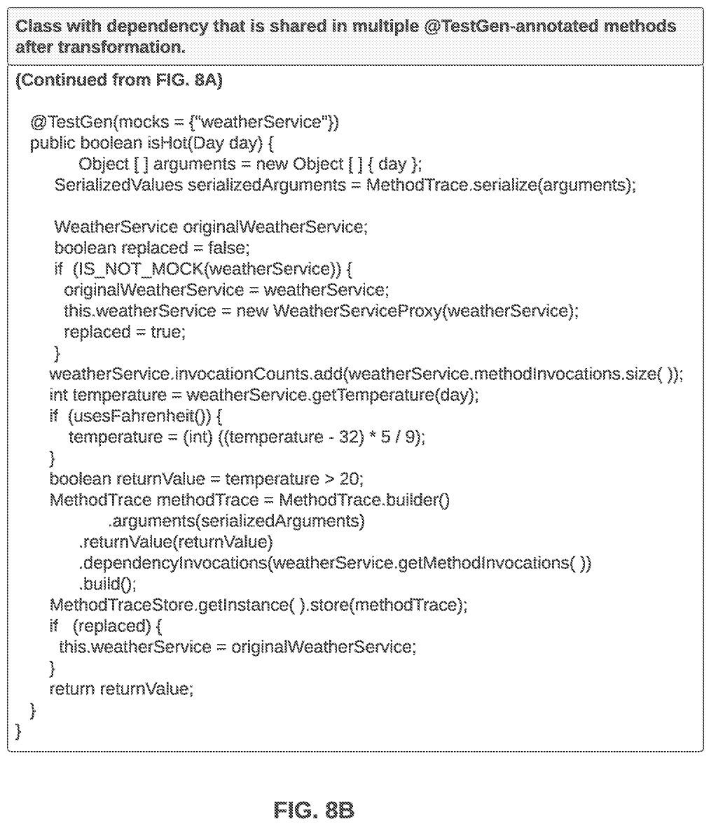

FIGS. 8A and 8B is the source code of the class of FIG. 7 after transformation. The invocationCounts field on the proxy is used to store how often a method on the proxy was invoked at the moment that another @TestGen-annotated method is entered. In this manner, when unravelling the call stack, the tracer knows which method calls on the proxy belong to each @TestGen-annotated method.

In an example, the isHot method is called. The isHot method replaces the weatherService instance by a proxy. The isHot method calls getTemperature on the proxy, and the proxy registers this invocation. The isHot method invokes usesFahrenheit. Since the weatherService is already replaced by a proxy, it is not replaced again. The usesFahrenheit method calls getUnit on the proxy, and the proxy registers this invocation. When exiting the usesFahrenheit method, the invocation counts are used to determine which invocations on the proxy are caused by the usesFahrenheit method. When exiting the isHot method, the weatherService proxy is replaced by the original.

In another example, the usesFahrenheit method is called. The usesFahrenheit method replaces the weatherService instance by a proxy. The usesFahrenheit method calls getUnit on the proxy, and the proxy registers this invocation. When exiting the usesFahrenheit method, the weatherService proxy is replaced by the original.

FIG. 9A-9D are tables describing the structure of an example method trace. More particularly, FIG. 9A details the fields, types, and descriptions of example method trace data, FIG. 9B details the fields, types, and descriptions of example serialized value storage data, FIG. 9C details fields, types, and descriptions of example method invocation data, and FIG. 9D details the fields, types, and descriptions of example method invocation result data.

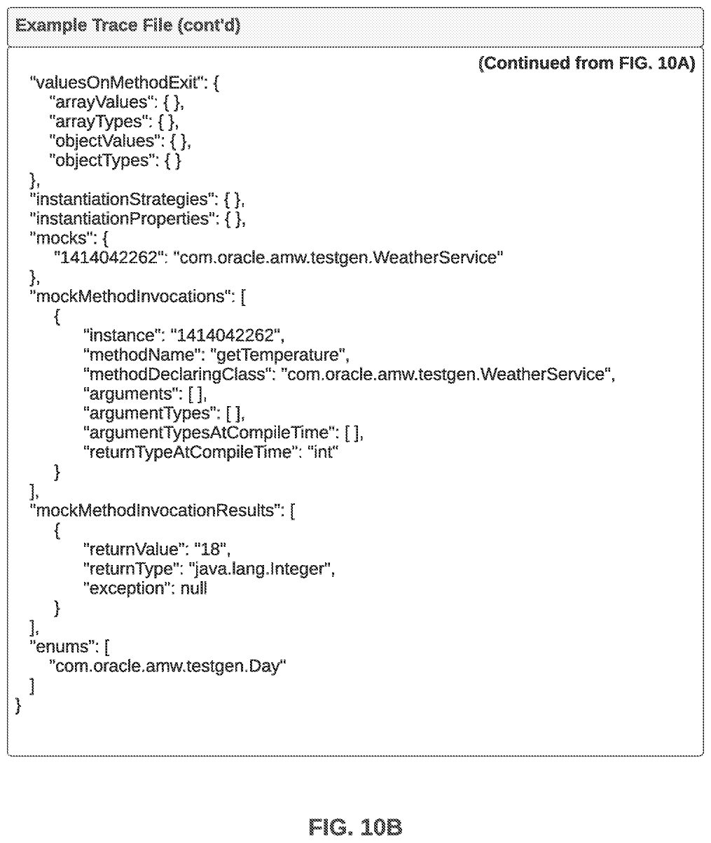

FIG. 10 is an example trace file resulting from execution of the source code of Figures. 8A and 8B after invoking the method isHot (Monday).

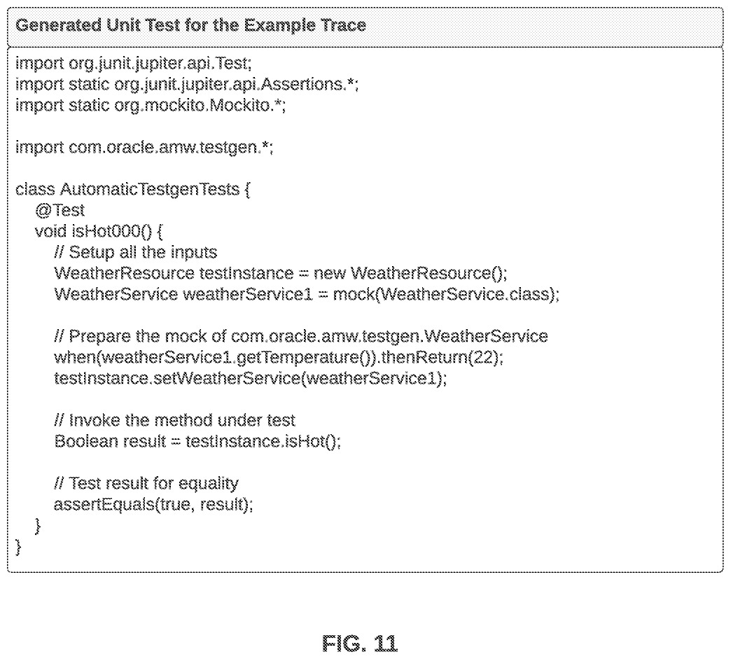

FIG. 11 is an example unit test generated for the example trace. More particularly, using the trace file as input and the operations described above, the generator tool generated the example unit test.

### 5. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

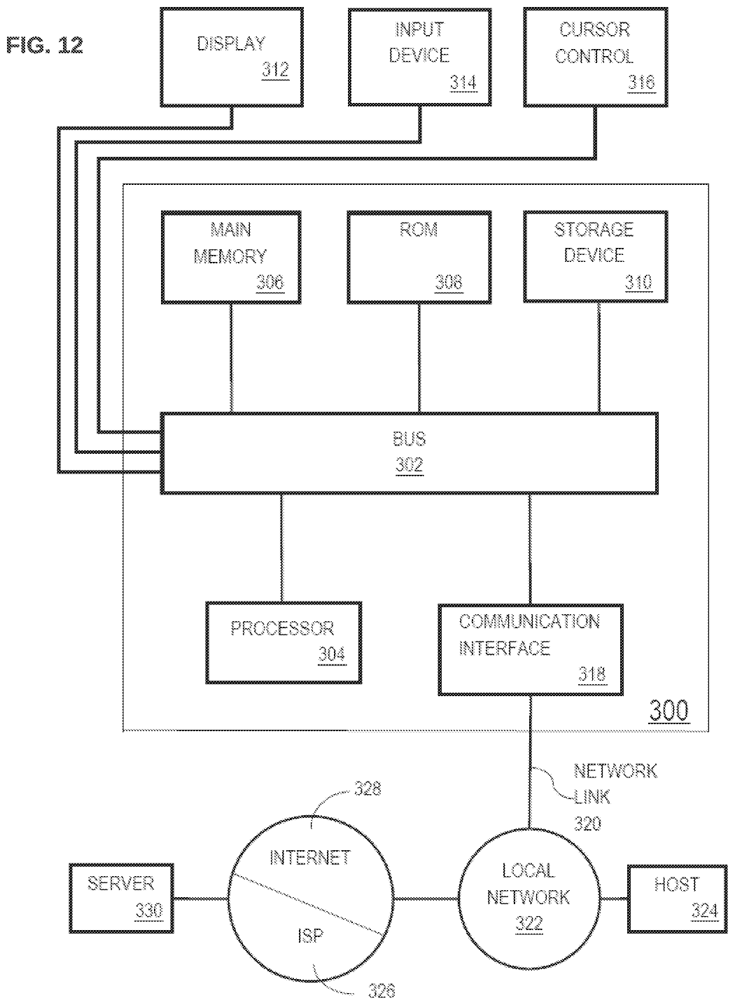

For example, FIG. 12 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the worldwide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### 6. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, causes performance of operations comprising:
traversing trace data to identify (a) a target method that was previously executed and traced, (b) a first set of one or more input values that were received by the target method for execution of the target method, and (c) a first return value that was returned by the target method;
based on the trace data, generating test code for testing the target method, the test code being configured to:
invoke the target method using a first set of one or more objects (a) being of types corresponding to the one or more input values and (b) comprising the one or more input values;
compare a second return value, to be returned by the target method in response to invoking the target method, to the first return value in the trace data;
executing the test code, wherein executing the test code comprises:
invoking the target method using the first set of one or more objects as arguments;
receiving the second return value returned by the target method in response to invoking the target method;
comparing the second return value to the first return value comprised in the trace data to determine whether the second return value matches the first return value;
determining test results based on the comparing operation;
wherein the first return value, comprised in the trace data, was generated by invocation of a first version of the target method, and wherein the second return value was generated by invocation of a second version of the target method; and
presenting or storing the test results.

2. The medium of claim 1, wherein the test code is further configured to:
instantiate the first set of one or more objects prior to invoking the target method.

3. The medium of claim 2, wherein the test code is further configured to:
instantiate an object of a type corresponding to the first return value, wherein the second return value is compared to the object of the type corresponding to the first return value.

4. The medium of claim 1, wherein presenting the test results includes indicating whether the second version of the target method passed or failed the test.

5. The medium of claim 1, wherein presenting the test results includes indicating (a) that the second return value is greater than the first return value or (b) that the second return value is lower than the first return value.

6. The medium of claim 1, wherein the operations further comprise creating the first set of one or more objects using a constructor method, a setter method or a builder class.

7. The medium of claim 1, wherein the first set of one or more input values and the first return value is serialized in the trace data, wherein the operations further comprise constructing the first set of one or more objects using the first set of one or more input values serialized in the trace data.

8. The medium of claim 1,
traversing trace data to identify (a) a first method that was invoked by the target method, (b) a second set of one or more input values that were received by the first method for execution of the first method, and (c) a second return value that was returned by the first method to the target method;
wherein the test code is further configured to:
create a proxy object, wherein invoking the first method, on the proxy object, using the second set of one or more input values results in returning the second return value.

9. The medium of claim 1, wherein the operations further comprise:
capturing the trace data, wherein capturing the trace data comprises:
traversing source code to identify the target method;
loading a class, including the target method, into a runtime environment, wherein loading the class comprises instrumenting byte code to trace the target method;
capturing the trace data during invocation of the target method; and
serializing and storing the trace data.

10. The medium of claim 9, wherein storing the trace data includes storing the trace data in a trace file on disk.

11. The medium of claim 9, wherein instrumenting the byte code to trace the target method comprises:
inserting instructions in the byte code (a) immediately before any executable code of the target method to capture a first state of the first set of one or more input values, and (b) immediately before a return command of the target method to capture the first return value.

12. The medium of claim 1, wherein the operations further comprise generating the trace data at least by:
(a) traversing source code to identify an annotation corresponding to the target method; and
(b) configuring generation of the trace data to trace the target method based on the annotation corresponding to the target method.

13. A method comprising:
traversing trace data to identify (a) a target method that was previously executed and traced, (b) a first set of one or more input values that were received by the target method for execution of the target method, and (c) a first return value that was returned by the target method;
based on the trace data, generating test code for testing the target method, the test code being configured to:
invoke the target method using a first set of one or more objects (a) being of types corresponding to the one or more input values and (b) comprising the one or more input values;
compare a second return value, to be returned by the target method in response to invoking the target method, to the first return value in the trace data;
executing the test code, wherein executing the test code comprises:
invoking the target method using the first set of one or more objects as arguments;
receiving the second return value returned by the target method in response to invoking the target method;
comparing the second return value to the first return value comprised in the trace data to determine whether the second return value matches the first return value;
determining test results based on the comparing operation;
wherein the first return value, comprised in the trace data, was generated by invocation of a first version of the target method, and wherein the second return value was generated by invocation of a second version of the target method; and
presenting or storing the test results.

14. The method of claim 13, wherein the test code is further configured to:
instantiate the first set of one or more objects prior to invoking the target method.

15. The method of claim 14, wherein the test code is further configured to:
instantiate an object of a type corresponding to the first return value, wherein the second return value is compared to the object of the type corresponding to the first return value.

16. The method of claim 13, wherein presenting the test results includes indicating whether the second version of the target method passed or failed the test.

17. The method of claim 13, wherein presenting the test results includes indicating (a) that the second return value is greater than the first return value or (b) that the second return value is lower than the first return value.

18. The method of claim 13, further comprising:
creating the first set of one or more objects using a constructor class, a setter method or a builder class.

19. The method of claim 13, wherein the first set of one or more input values and the first return value is serialized in the trace data, further comprising:
constructing the first set of one or more objects using the first set of one or more input values serialized in the trace data.

20. The method of claim 13,
traversing trace data to identify (a) a first method that was invoked by the target method, (b) a second set of one or more input values that were received by the first method for execution of the first method, and (c) a second return value that was returned by the first method to the target method;
wherein the test code is further configured to:
create a proxy object, wherein invoking the first method, on the proxy object, using the second set of one or more input values results in returning the second return value.

21. The method of claim 13, wherein the operations further comprise:
capturing the trace data, wherein capturing the trace data comprises:
traversing source code to identify the target method;
loading a class, including the target method, into a runtime environment, wherein loading the class comprises instrumenting byte code to trace the target method;
capturing the trace data during invocation of the target method; and
serializing and storing the trace data.

22. The method of claim 21, wherein storing the trace data includes storing the trace data in a trace file on disk.

23. The method of claim 21, wherein instrumenting the byte code to trace the target method comprises:
inserting instructions in the byte code (a) immediately before any executable code of the target method to capture a first state of the first set of one or more input values, and (b) immediately before a return command of the target method to capture the first return value.

24. The method of claim 13, wherein the operations further comprise generating the trace data at least by:
(a) traversing source code to identify an annotation corresponding to the target method; and
(b) configuring generation of the trace data to trace the target method based on the annotation corresponding to the target method.

25. A system comprising:
one or more processors; and
memory storing instructions that, when executed by the one or more processors, cause the system to perform:
traversing trace data to identify (a) a target method that was previously executed and traced, (b) a first set of one or more input values that were received by the target method for execution of the target method, and (c) a first return value that was returned by the target method;
based on the trace data, generating test code for testing the target method, the test code being configured to:
invoke the target method using a first set of one or more objects (a) being of types corresponding to the one or more input values and (b) comprising the one or more input values;
compare a second return value, to be returned by the target method in response to invoking the target method, to the first return value in the trace data;
executing the test code, wherein executing the test code comprises:
invoking the target method using the first set of one or more objects as arguments;
receiving the second return value returned by the target method in response to invoking the target method;
comparing the second return value to the first return value comprised in the trace data to determine whether the second return value matches the first return value;
determining test results based on the comparing operation;
wherein the first return value, comprised in the trace data, was generated by invocation of a first version of the target method, and wherein the second return value was generated by invocation of a second version of the target method; and
presenting or storing the test results.
